(19) United States
(12) Patent Application Publication
(10) Pub. No.: US 2020/0229216 A1
(43) Pub. Date: Jul. 16, 2020

(54) DOWNLINK CONTROL INFORMATION TRANSMISSION METHOD AND APPARATUS

(71) Applicant: BEIJING XIAOMI MOBILE SOFTWARE CO., LTD., Beijing (CN)

(72) Inventor: Yajun ZHU, Beijing (CN)

(73) Assignee: BEIJING XIAOMI MOBILE SOFTWARE CO., LTD., Beijing (CN)

(21) Appl. No.: 16/651,088

(22) PCT Filed: Sep. 30, 2017
(86) PCT No.: PCT/CN2017/105062

§ 371 Date: Mar. 26, 2020

(51) Int. Cl. H04W 72/12; H04W 72/04; H04L 1/00

(52) U.S. Cl. CPC H04W 72/1263; H04W 72/042; H04L 1/0038; H04W 72/0446; H04W 72/0453; H04W 72/046

(57) ABSTRACT

A downlink control information transmission method includes: mapping a physical downlink control channel (PDCCH) carrying downlink control information (DCI) onto N preset physical resources, wherein N is an integer greater than or equals to 2; and transmitting the DCI on different preset physical resources via different service beams. As such, reliability of transmitting the DCI can be improved.

### TECHNICAL FIELD

The present disclosure relates to the field of the communication technology, and more particularly to a downlink control information transmission method and apparatus.

### BACKGROUND

In an LTE (Long Term Evolution) system, DCI (Downlink Control Information) is the downlink control information that carried via a PDCCH (Physical Downlink Control Channel), and transmitted to a terminal by a base station. The DCI includes information of uplink and downlink resource allocation, power control, and the like. After receiving the DCI, the terminal may perform uplink data transmission or downlink data reception on a corresponding time-frequency resource based on an indication in the DCI.

### SUMMARY

Embodiments of the present disclosure provide a downlink control information transmission method and apparatus. The technical solutions are as follows:

According to a first aspect of embodiments of the present disclosure, a downlink control information transmission method is provided. The method is applied to a base station and includes:

mapping a physical downlink control channel (PDCCH) carrying downlink control information (DCI) onto N preset physical resources, wherein N is an integer greater than or equals to 2; and

transmitting the DCI on different preset physical resources via different service beams.

In one embodiment, mapping the physical downlink control channel (PDCCH) carrying the downlink control information (DCI) onto the N preset physical resources includes:

mapping the DCI with the same information content on each of the N preset physical resources,

wherein a transmission format of the DCI is different or the same, and the transmission format includes at least one of the following formats: an encoding mode, a DCI format, an aggregation level, a time-domain resource location, a frequency-domain resource location, and a resource mapping mode.

In one embodiment, mapping the physical downlink control channel (PDCCH) carrying the downlink control information (DCI) onto the N preset physical resources includes:

mapping the DCI with different information contents onto each preset physical resource.

In one embodiment, mapping the physical downlink control channel (PDCCH) carrying the downlink control information (DCI) onto the N preset physical resources includes:

mapping the PDCCH carrying one piece of DCI onto the N preset physical resources.

According to a second aspect of embodiments of the present disclosure, a downlink control information transmission method is provided. The method is applied to a terminal and includes:

receiving downlink control information (DCI) on M service beams configured by a base station, wherein M is an integer greater than or equals to 2; and

decoding the DCI to obtain an information content in the DCI.

In one embodiment, receiving downlink control information (DCI) on M service beams configured by a base station includes:

receiving the DCI with the same information content on different service beams, wherein a transmission format of the DCI is different or the same, and the transmission format includes at least one of the following formats: an encoding mode, a DCI format, an aggregation level, a time-domain resource location, a frequency-domain resource location, and a resource mapping mode;

decoding the DCI to obtain the control information includes:

jointly decoding the DCI, which is received on different service beams, with the same information content to obtain the same information content in the DCI.

In one embodiment, at least one of transmission formats of the DCI received on different service beams is the same; and decoding the DCI to obtain an information content in the DCI includes:

performing blind detection on first DCI received on a first service beam to obtain a transmission format of the first DCI;

determining a format the same as that of the first DCI in a transmission format of second DCI received on a second service beam according to the transmission format of the first DCI;

performing blind detection on the second DCI received on the second service beam according to the format the same as that of the first DCI to obtain the transmission format of the second DCI; and

decoding the first DCI and the second DCI respectively according to the transmission format of the first DCI and the transmission format of the second DCI to obtain information contents in the first DCI and the second DCI.

In one embodiment, receiving the downlink control information (DCI) on the M service beams includes:

receiving the DCI with different information contents on different service beams.

In one embodiment, receiving the downlink control information (DCI) on the M service beams includes:

receiving different information parts in one piece of DCI on different service beams;

decoding the DCI to obtain control information includes:

decoding the DCI in which the different information parts are received on different service beams so as to obtain an information content in the DCI.

According to a third aspect of embodiments of the present disclosure, a downlink control information transmission apparatus is provided. The apparatus is applied to a base station and includes:

a mapping module configured to map a physical downlink control channel (PDCCH) carrying downlink control information (DCI) onto N preset physical resources, wherein N is an integer greater than or equals to 2; and

a sending module configured to transmit the DCI on different preset physical resources via different service beams.

In one embodiment, the mapping module includes:

a first mapping subunit configured to map DCI with the same information content on each of the N preset physical resources,

wherein a transmission format of the DCI is different or the same, and the transmission format includes at least one of the following formats: an encoding mode, a DCI format, an aggregation level, a time-domain resource location, a frequency-domain resource location, and a resource mapping mode.

In one embodiment, the mapping module includes:

a second mapping subunit configured to map DCI with different information contents onto each preset physical resource.

In one embodiment, the mapping module includes:

a third mapping subunit configured to map a PDCCH carrying one piece of DCI onto the N preset physical resources.

According to a fourth aspect of embodiments of the present disclosure, a downlink control information transmission apparatus is provided. The apparatus is applied to a terminal and includes:

a receiving module configured to receive downlink control information (DCI) on M service beams configured by a base station, wherein M is an integer greater than or equals to 2; and

a decoding module configured to decode the DCI to obtain an information content in the DCI.

In one embodiment, the receiving module includes:

a first receiving submodule configured to receive DCI with the same information content on different service beams, wherein a transmission format of the DCI is different or the same, and the transmission format includes at least one of the following formats: an encoding mode, a DCI format, an aggregation level, a time-domain resource location, a frequency-domain resource location, and a resource mapping mode; and

the decoding module includes:

a first decoding submodule configured to jointly decode the DCI, which is received on different service beams, with the same information content so as to obtain the same information content in the DCI.

In one embodiment, at least one of transmission formats of the DCI received on different service beams is the same; and the decoding module includes:

a first blind detection submodule configured to perform blind detection on first DCI received on a first service beam to obtain a transmission format of the first DCI;

a determining submodule configured to determine a format the same as that of the first DCI in a transmission format of second DCI received on the second service beam according to the transmission format of the first DCI;

a second blind detection submodule configured to perform blind detection on the second DCI received on the second service beam according to the format the same as that of the first DCI to obtain the transmission format of the second DCI; and

a second decoding submodule configured to decode the first DCI and the second DCI respectively according to the transmission format of the first DCI and the transmission format of the second DCI so as to obtain information contents in the first DCI and in the second DCI.

In one embodiment, the receiving module includes:

a second receiving submodule configured to receive DCI with different information contents on different service beams.

In one embodiment, the receiving module includes:

a third receiving submodule configured to receive different information parts in one piece of DCI on different service beams; and

the decoding module includes

a third decoding submodule configured to decode the DCI in which the different information parts are received on different service beams so as to obtain an information content in the DCI.

According to a fifth aspect of embodiments of the present disclosure, a downlink control information transmission apparatus is provided. The apparatus is applied to a base station and includes:

a processor;

a memory, which is configured to store a processor-executable instruction;

wherein the processor is configured to:

map a physical downlink control channel (PDCCH) carrying downlink control information (DCI) onto N preset physical resources, wherein N is an integer greater than or equals to 2; and

transmit the DCI on different preset physical resources via different service beams.

According to a sixth aspect of embodiments of the present disclosure, a downlink control information transmission apparatus is provided. The apparatus is applied to a terminal and includes:

a processor,

a memory, which is configured to store a processor-executable instruction;

wherein the processor is configured to:

receive downlink control information (DCI) on M service beams configured by a base station, wherein M is an integer greater than or equals to 2; and

decode the DCI to obtain an information content in the DCI.

According to a seventh aspect of embodiments of the present disclosure, a non-transitory computer-readable storage medium which has stored thereon a computer instruction is provided. The non-transitory computer-readable storage medium is applied to a base station, and the computer instruction implements steps in the method above when being executed by a processor.

According to an eighth aspect of embodiments of the present disclosure, a non-transitory computer-readable storage medium which has stored thereon a computer instruction is provided, wherein the non-transitory computer-readable storage medium is applied to a terminal, and the computer instruction implements steps in the method above when being executed by a processor.

In this embodiment, a PDCCH carrying DCI may be mapped onto N preset physical resources; and then the DCI is transmitted on different preset physical resources by using different service beams. Transmitting the DCI by using multiple service beams may improve the reliability of transmitting the DCI compared with transmitting the DCI by using a single service beam.

It is to be understood that both the foregoing general description and the following detailed description are exemplary and explanatory only and are not intended to limit the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flow diagram of a downlink control information transmission method according to an exemplary embodiment.

FIG. 2 is a schematic diagram illustrating transmission of information via multiple beams according to an exemplary embodiment.

FIG. 3 is a flow diagram of a downlink control information transmission method according to an exemplary embodiment.

FIG. 4 is a schematic diagram illustrating transmission of information via multiple beams according to an exemplary embodiment.

FIG. 5 is a schematic diagram illustrating transmission of information via multiple beams according to an exemplary embodiment.

FIG. 6 is a flow diagram of a downlink control information transmission method according to an exemplary embodiment.

FIG. 7 is a flow diagram of a downlink control information transmission method according to an exemplary embodiment.

FIG. 8 is a schematic diagram illustrating transmission of information via multiple beams according to an exemplary embodiment.

FIG. 9 is a flow diagram of a downlink control information transmission method according to an exemplary embodiment.

FIG. 10 is a flow diagram of a downlink control information transmission method according to an exemplary embodiment.

FIG. 11 is a flow diagram of a downlink control information transmission method according to an exemplary embodiment.

FIG. 12 is a flow diagram of a downlink control information transmission method according to an exemplary embodiment.

FIG. 13 is a flow diagram of a downlink control information transmission method according to an exemplary embodiment.

FIG. 14 is a flow diagram of a downlink control information transmission method according to an exemplary embodiment.

FIG. 15 is a flow diagram of a downlink control information transmission method according to an exemplary embodiment.

FIG. 16 is a flow diagram of a downlink control information transmission method according to an exemplary embodiment.

FIG. 17 is a flow diagram of a downlink control information transmission method according to an exemplary embodiment.

FIG. 18 is a block diagram of a downlink control information transmission apparatus according to an exemplary embodiment.

FIG. 19 is a block diagram of a downlink control information transmission apparatus according to an exemplary embodiment.

FIG. 20 is a block diagram of a downlink control information transmission apparatus according to an exemplary embodiment.

FIG. 21 is a block diagram of a downlink control information transmission apparatus according to an exemplary embodiment.

FIG. 22 is a block diagram of a downlink control information transmission apparatus according to an exemplary embodiment.

FIG. 23 is a block diagram of a downlink control information transmission apparatus according to an exemplary embodiment.

FIG. 24 is a block diagram of a downlink control information transmission apparatus according to an exemplary embodiment.

FIG. 25 is a block diagram of a downlink control information transmission apparatus according to an exemplary embodiment.

FIG. 26 is a block diagram of a downlink control information transmission apparatus according to an exemplary embodiment.

FIG. 27 is a block diagram of a downlink control information transmission apparatus according to an exemplary embodiment.

FIG. 28 is a block diagram of a downlink control information transmission apparatus according to an exemplary embodiment.

### DETAILED DESCRIPTION

Exemplary embodiments will be described in detail herein, examples of which are illustrated in the accompanying drawings. The following description refers to the accompanying drawings in which the same numbers in different drawings represent the same or similar elements unless otherwise indicated. The implementations set forth in the following exemplary embodiments do not represent all implementations consistent with the present disclosure. Rather, they are merely examples of devices and methods consistent with certain aspects of the present disclosure as detailed in the appended claims.

An Embodiment of a Base Station Side

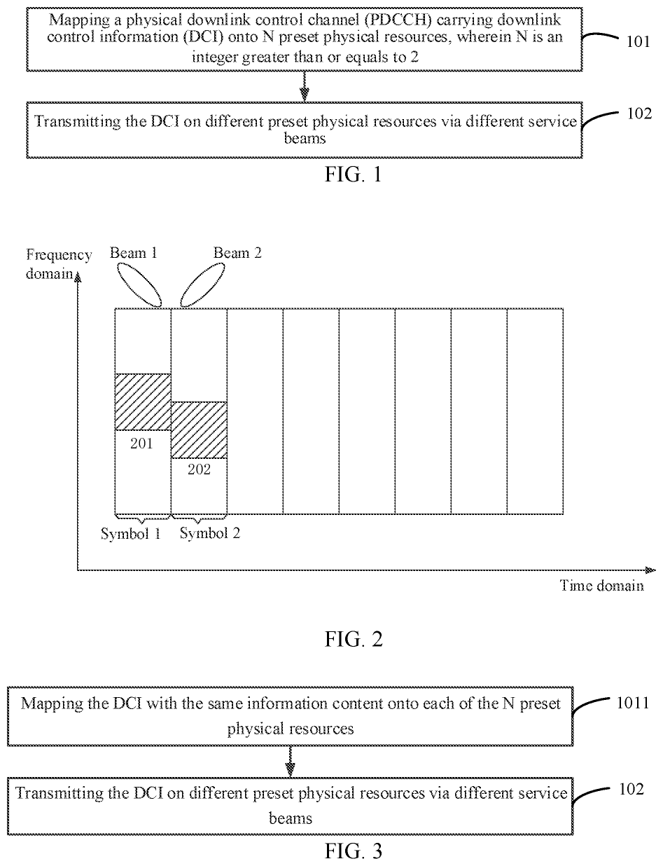

FIG. 1 is a flow diagram of a downlink control information transmission method according to an exemplary embodiment. The downlink control information transmission method is applied in a base station. As shown in FIG. 1, the method includes the following steps 101 and 102.

In step 101, a physical downlink control channel (PDCCH) carrying downlink control information (DCI) is mapped onto N preset physical resources, wherein N is an integer greater than or equals to 2.

In step 102, the DCI is transmitted on different preset physical resources via different service beams.

Here, in a new-generation wireless cellular communication system, a base station may operate in a higher-frequency band. In the higher-frequency band, due to high-frequency propagation characteristics, a signal will be heavily attenuated, with a relatively small coverage area. In order to enhance the coverage area, the base station will employ a beam transmission manner, one implementation of the beam transmission manner is to concentrate all transmit powers on one or more beams at the same time. In this way, the signal strength is improved.

Here, the base station may configure multiple service beams for the terminal according to actual situations, and beam configuration information of the base station to configure the service beams for the terminal is sent to the terminal. After receiving the beam configuration information, the terminal may acquire these service beams configured for the terminal by the base station. As such, the base station may transmit information to the terminal on these service beams, and the terminal may further receive the information transmitted by the base station on these service beams. Since transmission conditions of each service beam are different, transmitting the information by using multiple service beams may improve the reliability of transmitting the information. Exemplarily, FIG. 2 is a schematic diagram illustrating transmission of information via multiple beams according to an exemplary embodiment. As shown in FIG. 2, it is assumed that the two service beams configured by the base station for the terminal are a beam1 and a beam2, respectively. The information is transmitted on a symbol 1 via the beam1, and the information is transmitted on a symbol 2 via the beam2. The base station may transmit the information 1 on a time domain where the symbol 1 is located and a corresponding frequency domain via the beam1, and transmit the information 2 on a time domain where the symbol 2 is located and a corresponding frequency domain via the beam2. In this way, the terminal may receive the information 1 on the beam1 and the information 2 on the beam2. In this way, it is possible for the base station to have a lower signal strength when transmitting the information 1 on the beam1 and a higher signal strength when transmitting the information 2 on the beam2, so that the reliability of transmitting the information is relatively high.

Here, when the base station configures M (M is an integer greater than or equals to 2) service beams for the terminal, the base station may use the M service beams configured for the terminal to send DCI to the terminal, so as to improve the reliability of transmitting the DCI. When the base station transmits the DCI, there is a need for carrying the DCI on the PDCCH and then map the PDCCH onto a preset physical resource, and the PDCCH is transmitted by using the preset physical resource. Here, the preset physical resource includes a preset time-domain resource and a preset frequency-domain resource, that is, the base station transmits the PDCCH carrying the DCI on the preset time-domain resource and the preset frequency-domain resource. Here, when the base station is to send the DCI to the terminal via the M service beams configured for the terminal, the PDCCH carrying the DCI may be mapped onto N preset physical resources. Among the N preset physical resources, DCI on different preset physical resources may be transmitted by using different service beams. In this way, the base station may transmit the DCI, via different service beams, mapped onto different preset physical resources. Exemplarily, as shown in FIG. 2, the base station may map two PDCCHs carrying the DCI onto two preset physical resources, namely, a preset physical resource 201 and a preset physical resource 202, and the preset physical resource 201 includes a symbol 1 and a resource on its corresponding frequency, the preset physical resource 202 includes a symbol 2 and a resource on its corresponding frequency. The base station may send information on the symbol 1 by using the beam1, and send information on the symbol 2 by using the beam2. As such, the base station may send the DCI mapped onto the preset physical resource 201 on the preset physical resource 201 via the beam1, and the DCI mapped on the preset physical resource 202 on the preset physical resource 202 via the beam2, so that when the base station transmits the DCI on the beam1 and the beam2, sending the same or different DCI information by using multiple beams may improve the reliability of transmitting the DCI compared with transmitting the DCI by using a single beam.

With the technical solution provided by the embodiment of the present disclosure, the base station may map the PDCCH carrying DCI onto N preset physical resources; and transmit the DCI on different preset physical resources via different service beams. In this way, the base station may send the DCI mapped onto different preset physical resources to the terminal on different service beams. Sending the DCI by using different service beams may improve the reliability of transmitting the DCI compared with sending the DCI by using a single beam.

In one embodiment, FIG. 3 is a flow diagram of a downlink control information transmission method according to an exemplary embodiment. As shown in FIG. 3, the step 101 in the downlink control information transmission method may be implemented as the following step 1011.

In step 1011, the DCI with the same information content is mapped onto each of the N preset physical resources.

A transmission format of the DCI is different or the same, and the transmission format includes at least one of the following formats: an encoding mode, a DCI format, an aggregation level, a time-domain resource location, a frequency-domain resource location, and a resource mapping mode.

Here, the base station may separately carry the same DCI on N PDCCHs, and each PDCCH is mapped onto one preset physical resource, so that the DCI with the same information content is mapped onto different preset physical resources. As such, the base station may send the DCI mapped onto the preset physical resource to the terminal on different preset physical resources via different service beams, respectively. As such, the base station may repeatedly send the same DCI to the terminal on different service beams. After obtaining the DCI on the first service beam, the terminal may directly decode the DCI to obtain the information content in the DCI. Even if the terminal has a poor signal when receiving the DCI on the first service beam, it may only obtain a part of the information content in the DCI. The terminal may receive the same DCI on other service beams, and the DCI previously received and the DCI received on other service beams may be jointly decoded to obtain the information content in the DCI. As such, the base station repeatedly sends the same DCI to the terminal on the N service beams, respectively. Even if the transmission condition on one service beam is poor, it will not affect the transmission of the DCI on other service beams. Accordingly, it is possible to ensure that the DCI is transmitted perfectly with greater probability and to improve the reliability of transmitting the DCI.

Here, it should be noted that the transmission format when the base station transmits the DCI to the terminal may be different or the same. Here, the transmission format includes an encoding mode, a DCI format, an aggregation level, a time-domain resource location, a frequency-domain resource location, and a resource mapping mode. Here, the time-domain resource location is a time-domain resource location of the DCI in a control resource region, the frequency-domain resource location is a frequency-domain resource location of the DCI in the control resource region, and the resource mapping mode is a mapping mode of a PDCCH carrying the DCI. Here, the control resource region refers to a region of time-domain resources and frequency-domain resources onto which the PDCCH carrying the DCI is mapped.

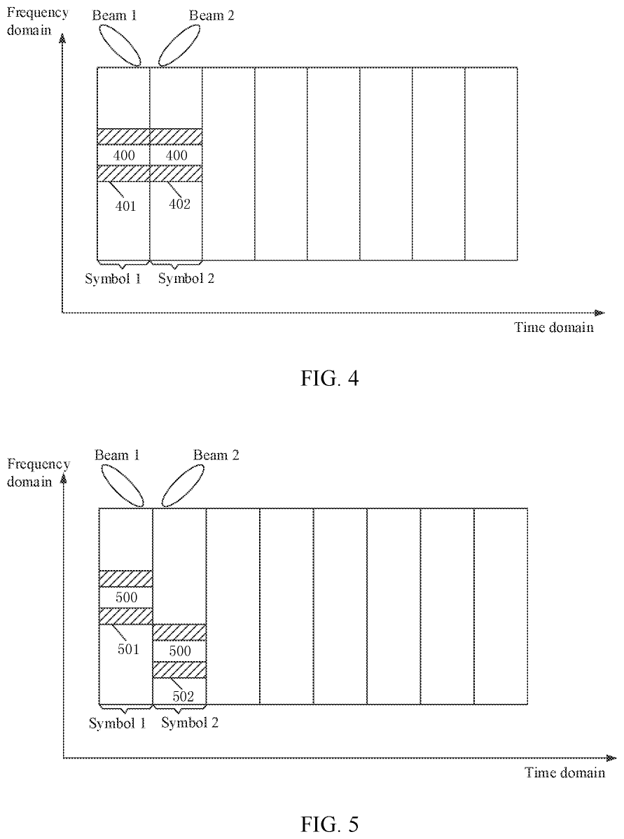

In one case, a transmission format of DCI transmitted by a base station on each preset resource block is the same. Exemplarily, FIG. 4 is a schematic diagram illustrating transmission of information via multiple beams according to an exemplary embodiment. As shown in FIG. 4, it is assumed that service beams configured by the base station for a terminal are a beam1 and a beam2, and two PDCCHs carrying DCI400 with the same information content are mapped onto two preset physical resources, namely, a preset physical resource 401 and a preset physical resource 402. The preset physical resource 401 includes a symbol 1 and a resource on its corresponding frequency, and the preset physical resource 402 includes a symbol 2 and a resource on its corresponding frequency. As such, the base station may send the DCI400 mapped onto the preset physical resource 401 on the preset physical resource via the beam1, and send the DCI400 mapped onto the preset physical resource 402 on the preset physical resource 402 via beam2. As such, the base station sends the DCI400 with the same information content on the beam1 and the beam2, and the transmission format of the DCI400 is the same. As may be seen from FIG. 4, the frequency-domain position of the DCI400 in the control resource region during transmission is exactly the same, the resource mapping mode of the DCI400 is the same, and the aggregation level of the DCI400 is exactly the same. In this way, when the transmission format when the base station transmits the DCI to the terminal is the same, the terminal may obtain the transmission format of the DCI400 by means of blind detection when receiving the DCI400 on the beam1. In this way, the terminal may obtain the transmission format of the DCI400 without the blind detection when receiving the DCI400 on the beam2. The terminal may directly decode the DCI400 received on the beam2 to obtain the information content in the DCI400, which may reduce the number of blind detections of the terminal.

In another case, a transmission format of DCI transmitted by a base station on each preset resource block is different. For example, FIG. 5 is a schematic diagram illustrating transmission of information via beams according to an exemplary embodiment. As shown in FIG. 5, it is assumed that service beams configured by the base station for a terminal are a beam1 and a beam2, one symbol occupied on a time domain by the beam1 serves as a symbol 1, one symbol occupied on the time domain by the beam2 serves as a symbol 2, and two PDCCHs carrying the DCI500 with the same information content are mapped onto two preset physical resources, namely, a preset physical resource 501 and a preset physical resource 502. The preset physical resource 501 includes a symbol 1 and a resource on its corresponding frequency, and the preset physical resource 502 includes a symbol 2 and a resource on its corresponding frequency. As such, the base station may send the DCI500 mapped onto the preset physical resource 501 on the preset physical resource 501 via the beam1, and send the DCI500 mapped onto the preset physical resource 502 on the preset physical resource 502 via the beam2. As such, the base station may send the DCI500 with the same information content on the beam1 and the beam2. However, the transmission format of the DCI500 is different. As shown in FIG. 5, frequency-domain locations of the DCI500 in a control resource region are different, and resource mapping modes of the PDCCHs are different. In this way, the transmission format of the DCI transmitted by the base station on each preset resource block is different. As shown in FIG. 5, the base station may transmit the DCI500 in different frequency domains. In this way, it is possible for the base station to have lower signal strength when transmitting the DCI500 in one of the frequency domains and higher signal strength when transmitting the DCI500 in another of the frequency domains. In this way, the reliability of the DCI may be further ensured.

With the technical solution provided by the embodiment of the present disclosure, the base station may map the DCI with the same information content onto each of the N preset physical resources, so that the base station may transmit the DCI with the same information content on different service beams. Accordingly, the reliability of transmitting the DCI is further improved.

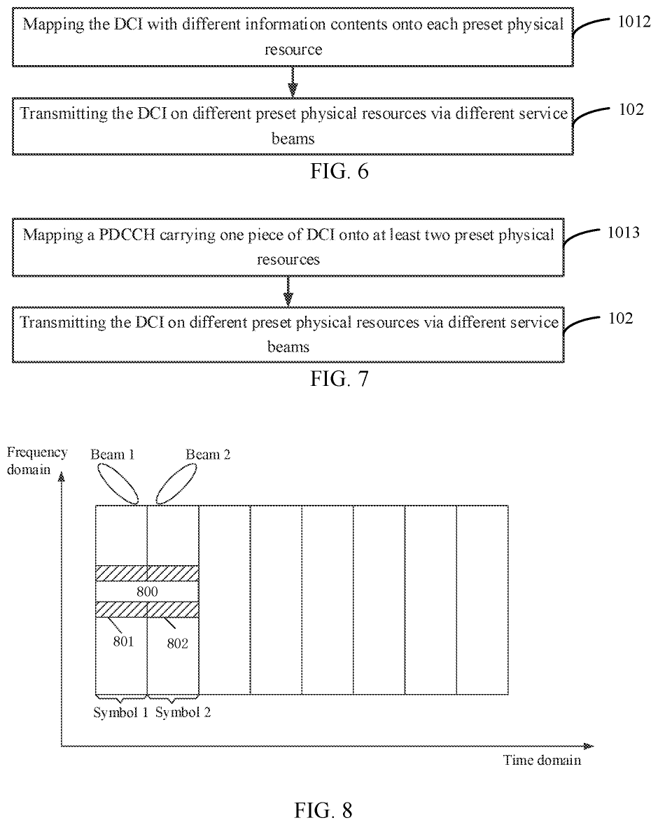

In one embodiment, FIG. 6 is a flow diagram of a downlink control information transmission method according to an exemplary embodiment. As shown in FIG. 6, the step 101 in the downlink control information transmission method may be implemented as the following step 1012.

In step 1012, the DCI with different information contents is mapped onto each preset physical resource.

Here, the base station may further map the DCI with different information contents onto each preset physical resource. For example, the base station may carry the DCI without any correlation on the information content on different PDCCHs, respectively, and each PDCCH is mapped onto a predetermined physical resource. In this way, the DCI with different information contents is mapped onto different preset physical resources, and the base station sends the DCI mapped onto the preset physical resource to the terminal on different preset physical resources via different service beams, respectively. As such, the base station may send the DCI with different information contents to the terminal on different service beams. After obtaining the DCI on a first service beam, the terminal may decode the DCI to obtain the information content in the DCI. After obtaining the DCI on a second service beam, the terminal may decode the DCI to obtain the information content in the DCI. The information contents of two pieces of DCI are different. As such, the base station may send different pieces of DCI by using different service beams, and may transmit more pieces of DCI, with higher efficiency of transmitting the DCI.

With the technical solution provided by the embodiment of the present disclosure, the base station may map the DCI with different information contents onto each preset physical resource, so that the base station may transmit the DCI with different information contents on different service beams. Accordingly, the efficiency of transmitting the DCI is improved.

In one embodiment, FIG. 7 is a flow diagram of a downlink control information transmission method according to an exemplary embodiment. As shown in FIG. 7, the step 101 in the downlink control information transmission method may be implemented as the following step 1013.

In step 1013, a PDCCH carrying one piece of DCI is mapped onto at least two preset physical resources.

Here, the DCI carried on the PDCCH configured by a base station has a large amount of data and is sent without more resources. The base station may map the PDCCH carrying one piece of DCI onto at least two preset physical resources. In this way, the base station sends the DCI mapped onto the preset physical resource to the terminal on different preset physical resources via different service beams, respectively. That is, the base station jointly sends the same DCI to the terminal by using different service beams.

Exemplarily, FIG. 8 is a schematic diagram illustrating transmission of information via multiple beams according to an exemplary embodiment. As shown in FIG. 8, it is assumed that service beams configured by a base station for a terminal are a beam1 and a beam2, and one PDCCH carrying DCI800 is mapped onto two preset physical resources, namely, a preset physical resource 801 and a preset physical resource 802. The preset physical resource 801 includes a symbol 1 and a resource on its corresponding frequency, and the preset physical resource 802 includes a symbol 2 and a resource on its corresponding frequency. Accordingly, the base station may send a part of the DCI800 mapped onto the preset physical resource 801 on the preset physical resource 801 via the beam1, and send the other part of the DCI800 mapped onto the preset physical resource 802 on the preset physical resource 802 via the beam2. That is, the base station sends a part of the DCI800 on the beam1 and the other part of the DCI800 on the beam2. The base station jointly sends the DCI800 on the beam1 and the beam2.

With the technical solution provided by the embodiment of the present disclosure, the base station may map a PDCCH carrying one piece of DCI onto N preset physical resources, so that the base station may jointly transmit one piece of DCI on different service beams, and may transmit the DCI with a relatively large amount of data.

An Embodiment of a Terminal Side

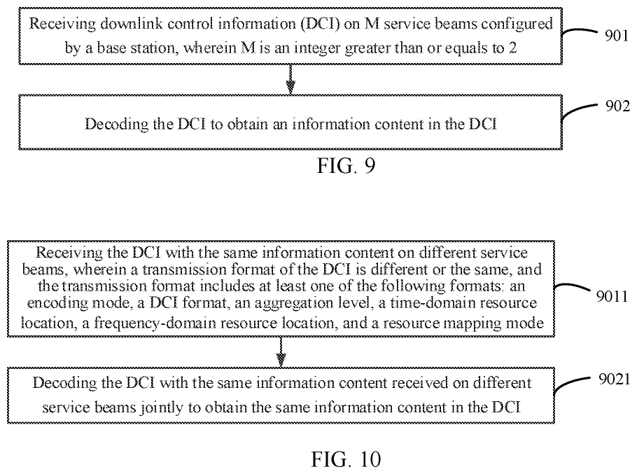

FIG. 9 is a flow diagram of a downlink control information transmission method according to an exemplary embodiment. The downlink control information transmission method is applied in a terminal. As shown in FIG. 9, the method includes the following steps 901 and 902.

In step 901, downlink control information (DCI) is received on M service beams configured by a base station, wherein M is an integer greater than or equals to 2.

In step 902, the DCI is decoded to obtain an information content in the DCI.

Here, the base station configures M (M is an integer greater than or equals to 2) service beams for the terminal according to actual needs, and may send beam configuration information of the base station to configure the service beam for the terminal to the terminal. The terminal may acquire these service beams configured by the base station for the terminal after receiving the beam configuration information. As such, the base station may send the DCI to the terminal on these service beams, and the terminal may further receive the DCI transmitted by the base station on these service beams. Exemplarily, as shown in FIG. 2, the base station transmits the DCI mapped onto a preset physical resource 201 on the preset physical resource 201 via the beam1 and the DCI mapped onto a preset physical resource 202 on the preset physical resource 202 via the beam2. As such, the terminal may receive the DCI on the preset physical resource 201 on the beam and the DCI on the preset physical resource 202 on the beam2. The terminal may decode the received DCI to obtain the information content in the DCI. The information content in the DCI includes information such as uplink and downlink resource allocation and power control. After acquiring the information content in the DCI, the terminal may perform uplink data transmission or downlink data reception on corresponding time-frequency resources.

With the technical solution provided by the embodiment of the present disclosure, the terminal may receive the DCI on at least two service beams. Accordingly, the reliability of transmitting the DCI may be improved.

In one embodiment, FIG. 10 is a flow diagram of a downlink control information transmission method according to an exemplary embodiment. As shown in FIG. 10, the step 901 in the downlink control information transmission method may be implemented as the following step 9011, and the step 902 may be implemented as the following step 9021.

In step 9011, the DCI with the same information content is received on different service beams, wherein a transmission format of the DCI is different or the same, and the transmission format includes at least one of the following formats: an encoding mode, a DCI format, an aggregation level, a time-domain resource location, a frequency-domain resource location, and a resource mapping mode.

In step 9021, the DCI with the same information content received on different service beams is jointly decoded to obtain the same information content in the DCI.

Here, the base station may send DCI with the same information content to the terminal on different beams as shown in FIG. 3 or FIG. 4, and the terminal may receive the first DCI sent on the beam1 on a time domain where a symbol 1 is located and the second DCI sent on the beam2 on a time domain where a symbol 2 is located. Information contents in the first DCI and the second DCI are exactly the same. At this time, the terminal may receive the first DCI sent on the beam1 on the time domain where the symbol 1 is located, and then may directly decode the first DCI to obtain the information content in the first DCI. Since the information contents in the first DCI and the second DCI are the same, there is no need for the terminal to decode the second DCI. However, in some cases, if a transmission condition on the beam1 is poor, the terminal may only receive partially valid first DCI on the beam1. At this time, after receiving the second DCI on the beam2, there is a need for the terminal to jointly decode the received first DCI and the received second DCI to obtain the same information content in the first DCI and the second DCI. Accordingly, it is possible to ensure that the terminal may obtain the complete information content, and improve the reliability of transmitting the DCI.

With the technical solution provided by the embodiment of the present disclosure, after receiving the DCI with the same information content on different service beams, the terminal may jointly decode the DCI with the same information content received on different service beams to obtain the same information content in the DCI. Accordingly, the reliability of transmitting the DCI is improved.

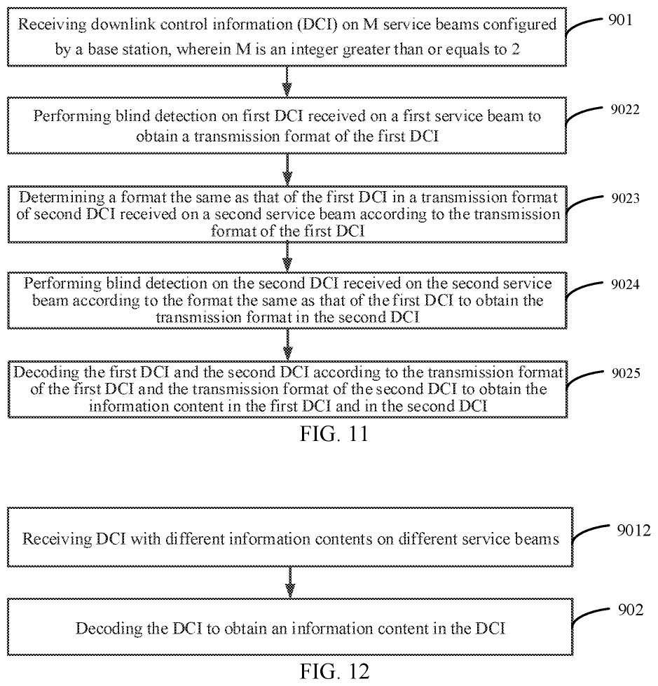

In one embodiment, at least one of transmission formats of the DCI received on different service beams is the same. FIG. 11 is flow diagram of a downlink control information transmission method according to an exemplary embodiment. As shown in FIG. 11, the step 902 in the downlink control information transmission method may be implemented as the following steps 9022 to 9025.

In step 9022, blind detection is performed on first DCI received on a first service beam to obtain a transmission format of the first DCI.

In step 9023, a format the same as that of the first DCI in a transmission format of second DCI received on a second service beam is determined according to the transmission format of the first DCI.

In step 9024, blind detection is performed on the second DCI received on the second service beam according to the format the same as that of the first DCI to obtain the transmission format in the second DCI.

In step 9025, the first DCI and the second DCI are decoded according to the transmission format of the first DCI and the transmission format of the second DCI to obtain the information content in the first DCI and in the second DCI.

Here, the transmission format includes an encoding mode, a DCI format, an aggregation level, a time-domain resource location, a frequency-domain resource location, a resource mapping mode, and the like. At least one of transmission formats of the DCI received on different service beams is the same. The same format is negotiated in advance by the base station and the terminal. One or more of preset transmission formats in the DCI sent by the base station to the terminal are the same. In this way, the terminal performs blind detection on the first DCI when receiving the first DCI on a first service beam. When performing blind detection, there is a need for the terminal to detect the first DCI by using various combinations of different types of transmission formats of the DCI supported by the base station one by one. If the detection is successful, the terminal obtains the transmission format of the first DCI. Because one or more of the transmission formats of the first DCI and the second DCI are the same, for example, the resource mapping mode is the same, which is a resource mapping mode 1, the terminal may determine that the resource mapping mode in the second DCI further serves as the resource mapping mode 1. In this way, when performing blind detection on the second DCI, there is only a need for the terminal to perform blind detection on the second DCI by using a combination with the resource mapping mode and perform blind detection on the second DCI, rather than using a combination with other resource mapping modes, and thus the number of the blind detections of the terminal is reduced. After obtaining the transmission format of the first DCI and the transmission format of the second DCI by means of the blind detection, the terminal may decode the first DCI and the second DCI, respectively to obtain information contents in the first DCI and in the second DCI. Here, the information contents in the first DCI and in the second DCI may be the same or different.

With the technical solution provided by the embodiment of the present disclosure, the terminal may determine a format the same as that of the first DCI in a transmission format of second DCI received on a second service beam based on the transmission format, which is obtained by means of the blind detection, of the first DCI received on the first service beam. In this way, when the blind detection is performed on the transmission format of the second DCI, the number of the blind detections of the terminal may be reduced, and the information decoding efficiency of the terminal may be improved.

In one embodiment, FIG. 12 is a flow diagram of a downlink control information transmission method according to an exemplary embodiment. As shown in FIG. 12, the step 901 in the downlink control information transmission method may be implemented as the following step 9012.

In step 9012, DCI with different information contents is received on different service beams.

Here, the base station may map the DCI with different information contents onto each preset physical resource, and the base station sends the DCI mapped onto the preset physical resource to the terminal on different preset physical resources via different service beams. In this way, the base station sends the DCI with different information contents on each service beam, and the terminal may receive the DCI with different information contents on different service beams. It is assumed that the base station sends the first DCI on the first service beam and the second DCI on the second service beam, the terminal may receive the first DCI on the first service beam and decode the first DCI to obtain the information content in the first DCI, and receive the second DCI on the second service beam and decode the second DCI to obtain the information content in the second DCI.

Here, it should be noted that the transmission formats of the first DCI and the second DCI may be the same or different, which will not be limited here. The transmission format of the DCI may include an encoding mode, a DCI format, an aggregation level, a time-domain resource location, a frequency-domain resource location, and a resource mapping mode. If the transmission formats of the first DCI and the second DCI are exactly the same, when the terminal receives the first DCI on the first service beam, the terminal may obtain the transmission format of the first DCI as a transmission format 1 by means of the blind detection. In this way, when the terminal receives the second DCI on the second service beam, the terminal may obtain the transmission format of the second DCI as the transmission format 1 without blind detection. The terminal may directly decode the second DCI received on the second service beam to obtain the information content in the second DCI, so that the number of the blind detections of the terminal may be reduced. If at least one of the transmission formats of the first DCI and the second DCI is the same, the terminal may obtain the transmission format of the first DCI by means of the blind detection when receiving the first DCI on the first service beam. Since one or more of the transmission formats of the DCI and the second DCI are the same, the terminal may determine one or more formats the same as that of the first DCI in the transmission format of the second DCI. In this way, when performing blind detection on the second DCI, the terminal performs blind detection on the second DCI only by using a combination of transmission formats to which the same one or more formats belong according to the format the same as that of the first DCI, and performs blind detection on the second DCI without using other combinations, so that the number of the blind detections of the terminal is reduced. The terminal decodes the first DCI and the second DCI according to the transmission format of the first DCI and the transmission format of the second DCI, so as to obtain information contents in the first DCI and in the second DCI. Certainly, the transmission formats of the first DCI and the second DCI may be exactly different. At this time, the terminal may perform blind detection on the first DCI and the second DCI, respectively, so as to obtain the respective transmission formats, and then decode the first DCI and the second DCI, respectively so as to obtain the information contents in the first DCI and in the second DCI.

With the technical solution provided by the embodiment of the present disclosure, the terminal may receive the DCI with different information contents on different service beams. Accordingly, the efficiency of transmitting the DCI is improved.

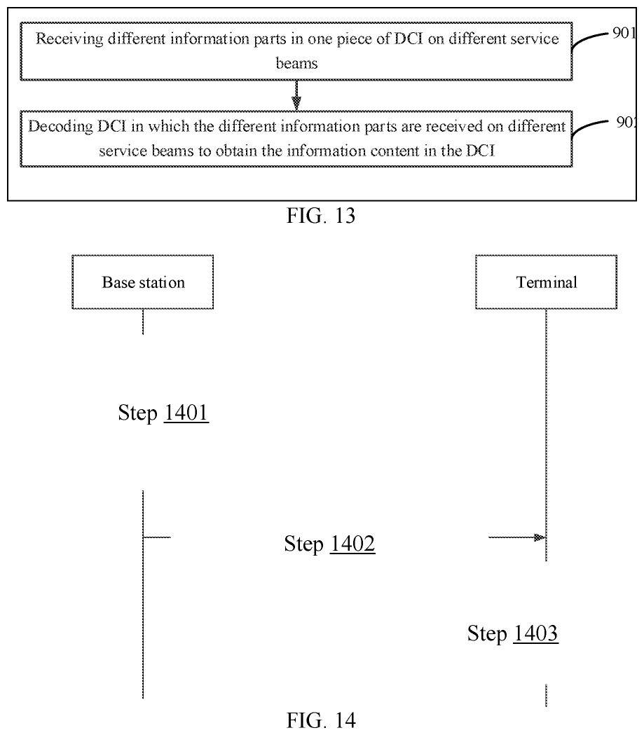

In one embodiment, FIG. 13 is a flow diagram of a downlink control information transmission method according to an exemplary embodiment. As shown in FIG. 13, the step 901 in the downlink control information transmission method may be implemented as the following step 9013, and the step 902 may be implemented as the following step 9022.

In step 9013, different information parts in one piece of DCI are received on different service beams.

In step 9026, DCI in which the different information parts are received on different service beams is decoded to obtain the information content in the DCI.

Here, the DCI carried on the PDCCH configured by the base station has a large amount of data and needs to be sent with more resources. The base station may map the PDCCH carrying one piece of DCI onto N preset physical resources. In this way, the base station sends the DCI mapped onto the preset physical resource to the terminal on different preset physical resources via different service beams, respectively. That is, the base station jointly sends the same DCI to the terminal via the N different service beams. In this way, the terminal may receive different information parts in one piece of DCI on different service beams. Exemplarily, as shown in FIG. 8, the base station may send information about a half of DCI800 on a beam1 and information about the other half of the DCI800 on a beam2. In this way, the terminal may receive information about of a half of DCI800 on the beam1 and receive information about the other half of the DCI800 on the beam2. There is a need for the terminal to decode the DCI in which all the different information parts are received on different service beams so as to obtain the information content in the DCI. In another case, if the redundancy of transmitting the DCI is relatively large, that is, there is a complete information content of the DCI in the information about a half of the DCI800 sent on the beam1 and a complete information content of the DCI in the information about the other half of the DCI800 sent on the beam2. At this time, the terminal may obtain the complete content in the DCI800 by decoding the information about a half of the DCI800 received on the beam1 only. Certainly, if it occurs some lost of information in a half information of the DCI800 received on the beam1 due to poor transmission conditions, the terminal may decode the information about the other half of the DCI800 received on the beam2 so as to obtain the complete content in the DCI800.

With the technical solution provided by the embodiment of the present disclosure, the terminal may receive different information in one piece of DCI on different service beams, and decode the DCI in which the different information parts are received on different service beams so as to obtain the information content in the DCI. One piece of DCI with a large amount of data transmitted by multiple service beams may be transmitted.

An implementation process will be described below in detail by means of several embodiments.

FIG. 14 is a flow diagram of a downlink control information transmission method according to an exemplary embodiment. The downlink control information transmission method is applied in a system where a base station and a terminal are located. As shown in FIG. 14, the method includes the following steps 1401 to 1403.

In step 1401, the base station maps a physical downlink control channel (PDCCH) carrying downlink control information (DCI) onto N preset physical resources, wherein the DCI with the same information content is mapped onto each of the N preset physical resources, and N is an integer greater than or equals to 2.

In step 1402, the base station transmits the DCI on different preset physical resources via different service beams, and the terminal receives the DCI with the same information content on different service beams.

A transmission format of the DCI is the same, and the transmission format includes at least one of the following formats: an encoding mode, a DCI format, an aggregation level, a time-domain resource location, a frequency-domain resource location, and a resource mapping mode.

In step 1403, the terminal jointly decodes the DCI, which is received on different service beams, with the same information content so as to obtain the same information content in the DCI.

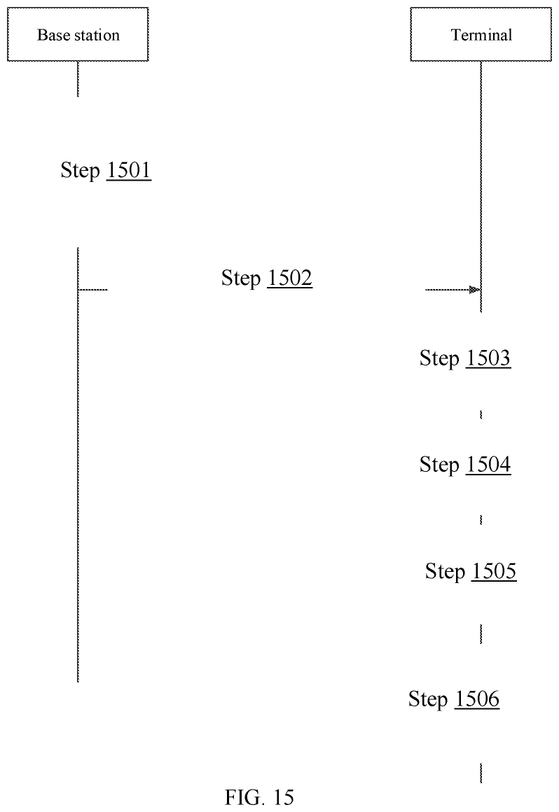

FIG. 15 is a flow diagram of a downlink control information transmission method according to an exemplary embodiment. The downlink control information transmission method is applied in a system where a base station and a terminal are located. As shown in FIG. 15, the method includes the following steps 1501 to 1506.

In step 1501, the base station maps a physical downlink control channel (PDCCH) carrying downlink control information (DCI) onto N preset physical resources, wherein DCI with the same information content is mapped onto each of the N preset physical resources, and N is an integer greater than or equals to 2.

In step 1502, the base station transmits the DCI on different preset physical resources via different service beams, and the terminal receives the DCI with the same information content on different service beams.

At least one of transmission formats of the DCI received on different service beams is the same.

In step 1503, the terminal performs blind detection on the first DCI received on a first service beam to obtain the transmission format of the first DCI.

In step 1504, the terminal determines a format the same as that of the first DCI in a transmission format of second DCI receive on a second service beam according to the transmission format of the first DCI.

In step 1505, the terminal performs blind detection on the second DCI received on the second service beam according to the format the same as that of the first DCI to obtain the transmission format of the second DCI.

In step 1506, the terminal decodes the first DCI and the second DCI respectively according to the transmission format of the first DCI and the transmission format of the second DCI to obtain information contents in the first DCI and in the second DCI.

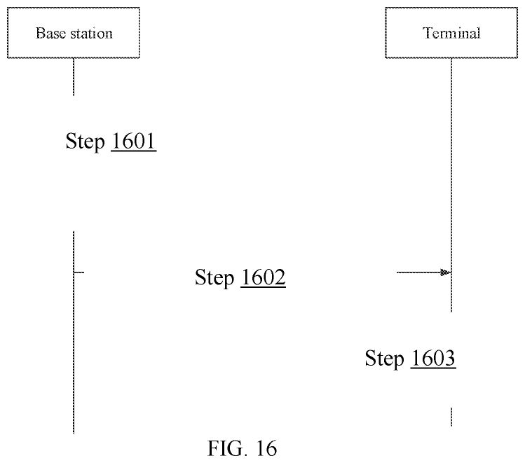

FIG. 16 is a flow diagram of a downlink control information transmission method according to an exemplary embodiment. The downlink control information transmission method is applied in a system where a base station and a terminal are located. As shown in FIG. 16, the method includes the following steps 1601 to 1603.

In step 1601, the base station maps a physical downlink control channel (PDCCH) carrying downlink control information (DCI) onto N preset physical resources, wherein DCI with different information contents is mapped onto each preset physical resource, and N is an integer greater than or equals to 2.

In step 1602, the base station transmits the DCI on different preset physical resources via different service beams, and the terminal receives DCI with different information contents on different service beams.

In step 1603, the terminal decodes the DCI with different information contents to obtain the information content in the DCI.

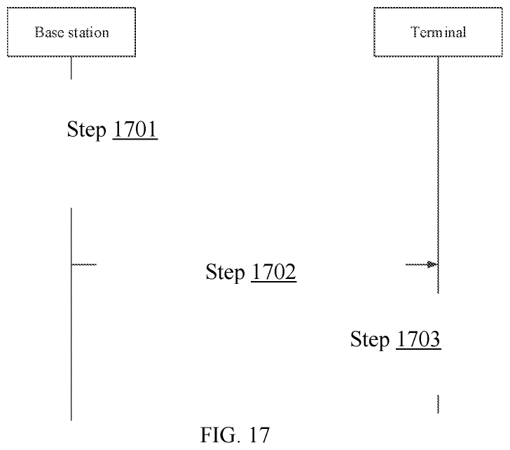

FIG. 17 is a flow diagram of a downlink control information transmission method according to an exemplary embodiment. The downlink control information transmission method is applied in a system where a base station and a terminal are located. As shown in FIG. 17, the method includes the following steps 1701 to 1703.

In step 1701, the base station maps a physical downlink control channel (PDCCH) carrying downlink control information (DCI) onto N preset physical resources, wherein a PDCCH carrying one piece of DCI is mapped onto the N preset physical resources, and N is an integer greater than or equals to 2.

In step 1702, the base station transmits the DCI on different preset physical resources via different service beams; and the terminal receives different information parts in one piece of DCI on different service beams.

In step 1703, the terminal decodes the DCI in which the different information parts are received on different service beams so as to obtain an information content in the DCI.

An embodiment of an apparatus of the present disclosure will be described below. The apparatus may be used to implement the embodiment of the method of the present disclosure.

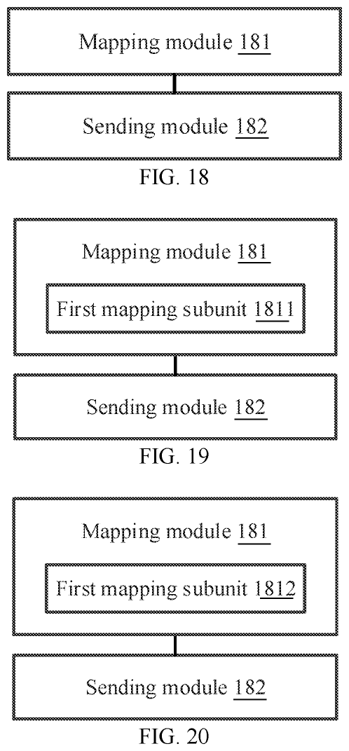

FIG. 18 is a block diagram of a downlink control information transmission apparatus according to an exemplary embodiment. The apparatus may be implemented as a part or all of a base station through software, hardware, or a combination of both. With reference to FIG. 18, the downlink control information transmission apparatus includes a mapping module 181 and a sending module 182, wherein

the mapping module 181 is configured to map a physical downlink control channel (PDCCH) carrying downlink control information (DCI) onto N preset physical resources, wherein N is an integer greater than or equals to 2: and

the sending module 182 is configured to transmit the DCI on different preset physical resources via different service beams.

As a possible embodiment, FIG. 19 is a block diagram of a downlink control information transmission apparatus according to an exemplary embodiment. As shown in FIG. 19, the downlink control information transmission apparatus disclosed above may further configure the mapping module 181 to include a first mapping subunit 1811, wherein

the first mapping subunit 1811 is configured to map DCI with the same information content onto each of the N preset physical resources, wherein a transmission format of the DCI is different or the same, and the transmission format includes at least one of the following formats: an encoding mode, a DCI format, an aggregation level, a time-domain resource location, a frequency-domain resource location, and a resource mapping mode.

As a possible embodiment, FIG. 20 is a block diagram of a downlink control information transmission apparatus according to an exemplary embodiment. As shown in FIG. 20, the downlink control information transmission apparatus disclosed above may further configure the mapping module 181 to include a first mapping subunit 1812, wherein

a second mapping subunit 1812 is configured to map DCI with different information contents onto each preset physical resource.

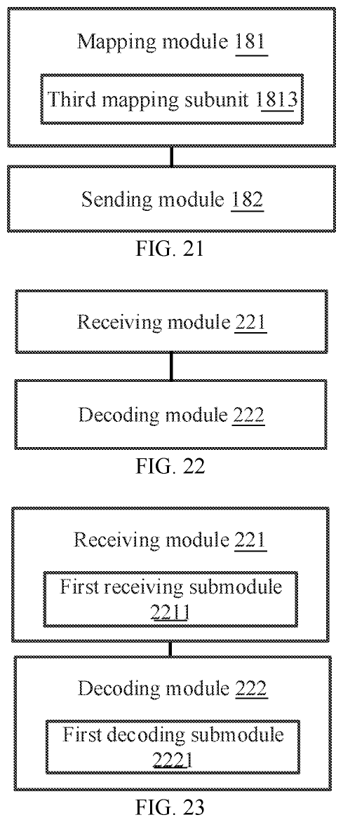

As a possible embodiment, FIG. 21 is a block diagram of a downlink control information transmission apparatus according to an exemplary embodiment. As shown in FIG. 21, the downlink control information transmission apparatus disclosed above may further configure the mapping module 181 to include a third mapping subunit 1813, wherein

the third mapping subunit 1813 is configured to map a PDCCH carrying one piece of DCI on the N preset physical resources.

FIG. 22 is a block diagram of a downlink control information transmission apparatus according to an exemplary embodiment. The apparatus may be implemented as a part or all of a base station through software, hardware, or a combination of both. With reference to FIG. 22, the downlink control information transmission apparatus includes a receiving module 221 and a decoding module 222, wherein

the receiving module 221 is configured to receive downlink control information (DCI) on M service beams configured by a base station, wherein M is an integer greater than or equals to 2; and

the decoding module 222 is configured to decode the DCI to obtain an information content in the DCI.

As a possible embodiment, FIG. 23 is a block diagram of a downlink control information transmission apparatus according to an exemplary embodiment. As shown in FIG. 23, the downlink control information transmission apparatus disclosed above may further configure the receiving module 221 to include a first receiving submodule 2211 and configure the decoding module 222 to include a first decoding submodule 2221, wherein

the first receiving submodule 2211 is configured to receive DCI with the same information content on different service beams, wherein a transmission format of the DCI is different or the same, and the transmission format includes at least one of the following formats: an encoding mode, a DCI format, an aggregation level, a time-domain resource location, a frequency-domain resource location and a resource mapping mode; and

the first decoding submodule 2221 is configured to jointly decode DCI with the same information content received on different service beams so as to obtain the same information content in the DCI.

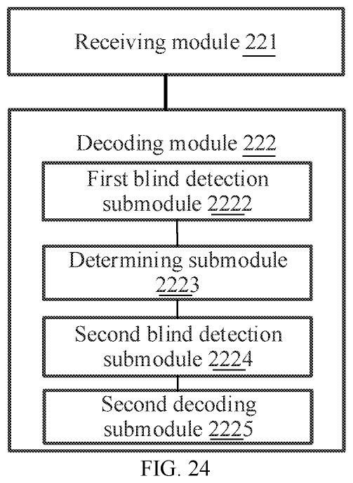

As a possible embodiment, at least one of transmission formats of the DCI received on different service beams is the same. FIG. 24 is a block diagram of a downlink control information transmission apparatus according to an exemplary embodiment. As shown in FIG. 24, the downlink control information transmission apparatus disclosed above may further configure the decoding module 222 to include a first blind detection submodule 2222, a determining submodule 2223, a second blind detection submodule 2224 and a second decoding submodule 2225, wherein

the first blind detection submodule 2222 is configured to perform blind detection on first DCI received on a first service beam to obtain a transmission format of the first DCI:

the determining submodule 2223 is configured to determine a format the same as that of the first DCI in a transmission format of second DCI received on a second service beam according to the transmission format of the first DCI;

the second blind detection submodule 2224 is configured to perform blind detection on the second DCI received on the second service beam according to the format the same as that the first DCI to obtain a transmission format of the second DCI; and

the second decoding submodule 2225 is configured to decode the first DCI and the second DCI respectively according to the transmission format of the first DCI and the transmission format of the second DCI so as to obtain information contents in the first DCI and in the second DCI.

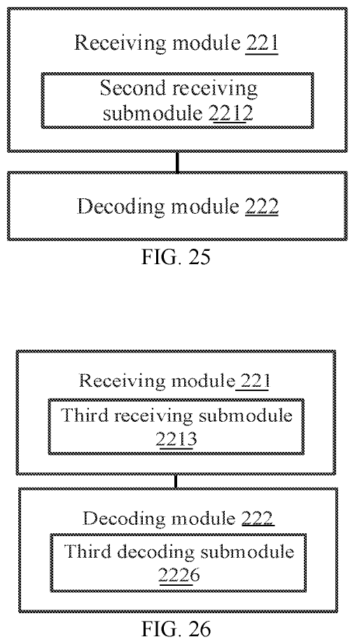

As a possible embodiment, FIG. 25 is a block diagram of a downlink control information transmission apparatus according to an exemplary embodiment. As shown in FIG. 25, the downlink control information transmission apparatus disclosed above may configure the receiving module 221 to include a second receiving submodule 2212, wherein

the second receiving submodule 2212 is configured to receive DCI with different information contents on different service beams.

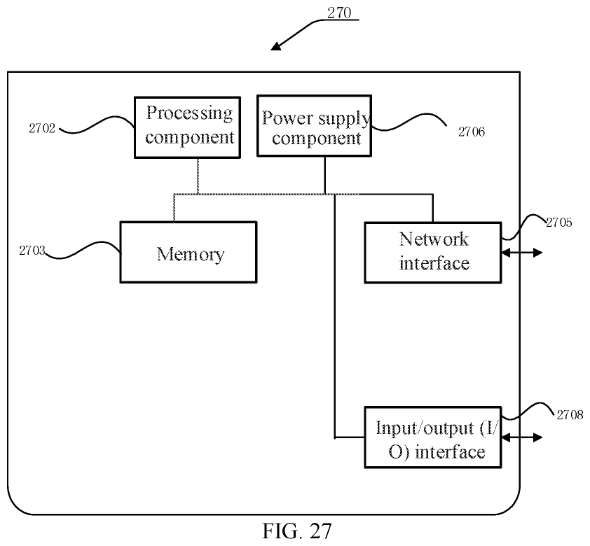

As a possible embodiment, FIG. 26 is a block diagram of a downlink control information transmission apparatus according to an exemplary embodiment. As shown in FIG. 26, the downlink control information transmission apparatus disclosed above may further configure the receiving module 221 to include a third receiving submodule 2213 and the decoding module 222 to include a third decoding submodule 2226, wherein

the third receiving submodule 2213 is configured to receive different information parts in one piece of DCI on different service beams; and

the third decoding submodule 2226 is configured to obtain an information content in the DCI for the DCI in which different information parts are received on different service beams so as to obtain an information content in the DCI.

With respect to the apparatus in the embodiment described above, a specific manner in which each module performs operations has been described in detail in the embodiment of the method, and will be omitted in detail here.

FIG. 27 is a block diagram of a downlink control information transmission apparatus according to an exemplary embodiment. The apparatus is suitable for a base station device. For example, the apparatus 270 may be a base station. The apparatus 270 includes a processing component 2702, which further includes one or more processors, and a memory resource represented by a memory 2703, for storing an instruction executable by the processing component 2702, such as an application program. The application program stored in the memory 2703 may include one or more modules each corresponding to a set of instructions. In addition, the processing component 2702 is configured to execute the instruction to perform the method described above.

The apparatus 270 may further include a power supply component 2706, which is configured to perform power management of the apparatus 270; a wired or wireless network interface 2705, which is configured to connect the apparatus 270 to a network; and an input/output (I/O) interface 2708. The apparatus 270 may operate based on an operating system stored in the memory 2703, such as Windows Server™, Mac OS X™, Unix™, Linux™, FreeBSD™ or the like.

A non-transitory computer-readable storage medium, when an instruction in a storage medium is executed by a processor of the apparatus 270, enables the apparatus 270 to perform the downlink control information transmission method described above. The method includes the following steps:

a physical downlink control channel (PDCCH) carrying downlink control information (DCI) is mapped onto N preset physical resources, wherein N is an integer greater than or equals to 2; and

the DCI is transmitted on different preset physical resources via different service beams.

In one embodiment, the method further includes:

that a physical downlink control channel (PDCCH) carrying downlink control information (DCI) is mapped onto N preset physical resources includes:

DCI with the same information content is mapped onto each of the N preset physical resources,

wherein a transmission format of the DCI is different or the same, and the transmission format includes at least one of the following formats: an encoding mode, a DCI format, an aggregation level, a time-domain resource location, a frequency-domain resource location, and a resource mapping mode.

In one embodiment, the method further includes:

that a physical downlink control channel (PDCCH) carrying downlink control information (DCI) is mapped onto N preset physical resources includes:

DCI with different information contents is mapped onto each preset physical resource.

In one embodiment, the method further includes:

that a physical downlink control channel (PDCCH) carrying downlink control information (DCI) is mapped onto N preset physical resources includes:

a PDCCH carrying one piece of DCI is mapped onto the N preset physical resources.

The present disclosure further provides a downlink control information transmission apparatus, which is applied to a base station and includes:

a processor;

a memory, which is configured to store a processor-executable instruction;

wherein the processor is configured to:

map a physical downlink control channel (PDCCH) carrying downlink control information (DCI) onto N preset physical resources, wherein N is an integer greater than or equals to 2; and

transmit the DCI on different preset physical resources via different service beams.

In one embodiment, the processor may be further configured to:

the mapping a physical downlink control channel (PDCCH) carrying downlink control information (DCI) on N preset physical resources includes:

DCI with the same information content is mapped onto each of the N preset physical resources;

wherein a transmission format of the DCI is different or the same, and the transmission format includes at least one of the following formats: an encoding mode, a DCI format, an aggregation level, a time-domain resource location, a frequency-domain resource location, and a resource mapping mode.

In one embodiment, the processor may be further configured to:

the mapping a physical downlink control channel (PDCCH) carrying downlink control information (DCI) onto N preset physical resources includes:

DCI with different information contents is mapped onto each preset physical resource.

In one embodiment, the processor may be further configured to:

the mapping a physical downlink control channel (PDCCH) carrying downlink control information (DCI) onto N preset physical resources includes:

a PDCCH carrying one piece of DCI is mapped onto the N preset physical resources.

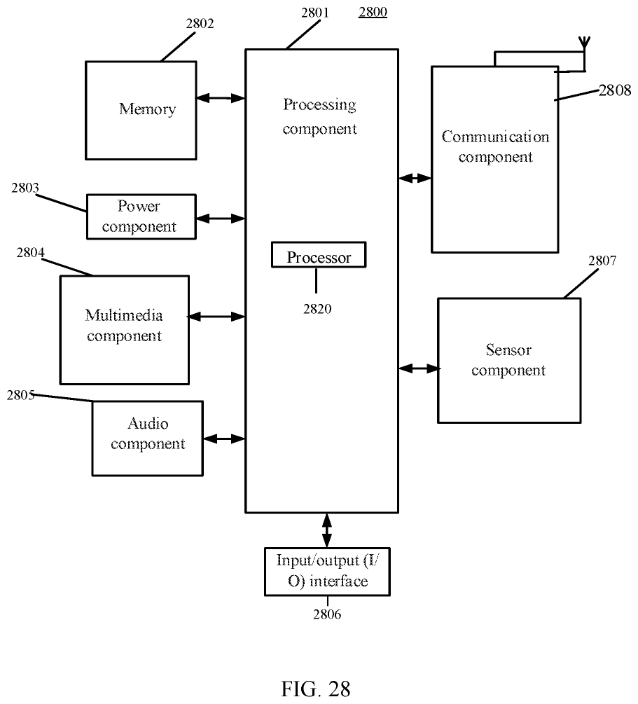

FIG. 28 is a block diagram of a downlink control information transmission apparatus according to an exemplary embodiment of the present disclosure. The apparatus is applied in a terminal device. For example, the apparatus 2800 may be a mobile phone, a game console, a computer, a tablet device, a personal digital assistant, and the like.

The apparatus 2800 may include one or more of the following components: a processing component 2801, a memory 2802, a power component 2803, a multimedia component 2804, an audio component 2805, an input/output (I/O) interface 2806, a sensor component 2807, and a communication component 2808.

The processing component 2801 typically controls overall operations of the apparatus 2800, such as the operations associated with display, telephone calls, data communications, camera operations, and recording operations. The processing component 2801 may include one or more processors 2820 to execute instructions to perform all or part of the steps in the above described methods. Moreover, the processing component 2801 may include one or more modules which facilitate the interaction between the processing component 2801 and other components. For instance, the processing component 2801 may include a multimedia module to facilitate the interaction between the multimedia component 2804 and the processing component 2801.

The memory 2802 is configured to store various types of data to support the operation of the apparatus 2800. Examples of such data include instructions for any applications or methods operated on the apparatus 2800, contact data, phonebook data, messages, pictures, video, etc. The memory 2802 may be implemented using any type of volatile or non-volatile memory devices, or a combination thereof, such as a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 2803 provides power to various components of the apparatus 2800. The power component 2803 may include a power management system, one or more power sources, and any other components associated with the generation, management, and distribution of power in the apparatus 2800.

The multimedia component 2804 includes a screen providing an output interface between the apparatus 2800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, slips, and gestures on the touch panel. The touch sensors may not only sense a boundary of a touch or slip action, but also sense a period of time and a pressure associated with the touch or slip action. In some embodiments, the multimedia component 2804 includes a front camera and/or a rear camera. The front camera and the rear camera may receive an external multimedia datum while the apparatus 2800 is in an operation mode, such as a photographing mode or a video mode. Each of the front camera and the rear camera may be a fixed optical lens system or have focus and optical zoom capability.

The audio component 2805 is configured to output and/or input audio signals. For example, the audio component 2805 includes a microphone (“MIC”) configured to receive an external audio signal when the apparatus 2800 is in an operation mode, such as a call mode, a recording mode, and a voice recognition mode. The received audio signal may be further stored in the memory 2802 or transmitted via the communication component 2808. In some embodiments, the audio component 2805 further includes a speaker to output audio signals.

The I/O interface 2806 provides an interface between the processing component 2801 and peripheral interface modules, such as a keyboard, a click wheel, buttons, and the like. The buttons may include, but are not limited to, a home button, a volume button, a starting button, and a locking button.

The sensor component 2807 includes one or more sensors to provide status assessments of various aspects of the apparatus 2800. For instance, the sensor component 2807 may detect an open/closed status of the apparatus 2800, relative positioning of components, e.g., the display and the keypad, of the apparatus 2800, a change in position of the apparatus 2800 or a component of the apparatus 2800, a presence or absence of user contact with the apparatus 2800, an orientation or an acceleration/deceleration of the apparatus 2800, and a change in temperature of the apparatus 2800. The sensor component 2807 may include a proximity sensor configured to detect the presence of nearby objects without any physical contact. The sensor component 2807 may also include a light sensor, such as a complementary metal oxide semiconductor (CMOS) or charge-coupled device (CCD) image sensor, for use in imaging applications. In some embodiments, the sensor component 2807 may also include an accelerometer sensor, a gyroscope sensor, a magnetic sensor, a pressure sensor, or a temperature sensor.

The communication component 2808 is configured to facilitate communication, wired or wirelessly, between the apparatus 2800 and other devices. The apparatus 2800 can access a wireless network based on a communication standard, such as WiFi, 2G, or 3G, or a combination thereof. In one exemplary embodiment, the communication component 2808 receives a broadcast signal or broadcast associated information from an external broadcast management system via a broadcast channel. In one exemplary embodiment, the communication component 2808 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 2800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components for executing the above methods.

In exemplary embodiments, there is also provided a non-transitory computer readable storage medium including instructions, such as the memory 2802 including instructions. These instructions may be loaded and executed by the processor 2820 in the apparatus 2800 for executing the above methods. For example, the non-transitory computer readable storage medium may be a ROM, a random-access memory (RAM), a CD-ROM, a magnetic tape, a floppy disk, an optical data storage device or the like.

The present disclosure further provides a computer-readable storage medium that implements the following steps when an instruction in a storage medium is executed by a processor of an apparatus 2800.

downlink control information (DCI) is received on M service beams configured by a base station, wherein M is an integer greater than or equals to 2; and

the DCI is decoded to obtain an information content in the DCI.

In one embodiment, the instruction in the storage medium may further implement the following steps when being executed by a processor:

that downlink control information (DCI) is received on M service beams configured by a base station includes:

DCI with the same information content is received on different service beams, wherein a transmission format of the DCI is different or the same, and the transmission format includes at least one of the following formats: an encoding mode, a DCI format, an aggregation level, a time-domain resource location, a frequency-domain resource location, and a resource mapping mode.

That the DCI is decoded to obtain an information content in the DCI includes:

the DCI with the same information content received on different service beams is jointly decoded to obtain the same information content in the DCI.

In one embodiment, the instruction in the storage medium may implement the following steps when being executed by a processor:

at least one of transmission formats of the DCI received on different service beams is the same; and that the DCI is decoded to obtain an information content in the DCI includes:

blind detection is performed on first DCI received on a first service beam to obtain a transmission format of the first DCI;

a format the same as that of the first DCI in a transmission format of second DCI received on the second service beam is determined according to the transmission format of the first DCI;

blind detection is performed on the second DCI received on the second service beam according to the format the same as that of the first DCI to obtain the transmission format in the second DCI; and

the first DCI and the second DCI are decoded respectively according to the transmission format of the first DCI and the transmission format of the second DCI so as to obtain information contents in the first DCI and in the second DCI.

In one embodiment, the instruction in the storage medium may implement the following steps when being executed by a processor:

that downlink control information (DCI) is received on M service beams includes:

DCI with different information contents is received on different service beams.

In one embodiment, the instruction in the storage medium may further implement the following steps when being executed by the processor:

that downlink control information (DCI) is received on M service beams includes:

different information parts in one piece of DCI are received on different service beams;

that the DCI is decoded to obtain control information includes:

the DCI in which the different information parts are received on different service beams is decoded so as to obtain an information content in the DCI.

The present disclosure further provides a downlink control information transmission apparatus, which is applied to a terminal and includes:

a processor,

a memory, which is configured to store a processor-executable instruction;

wherein the processor is configured to:

receive downlink control information (DCI) on M service beams configured by a base station is an integer greater than or equals to 2; and

decode the DCI to obtain an information content in the DCI.

In one embodiment, the processor may be further configured to:

the receiving downlink control information (DCI) on M service beams configured by a base station includes:

DCI with the same information content is received on different service beams, wherein a transmission format of the DCI is different or the same, and the transmission format includes at least one of the following formats: an encoding mode, a DCI format, an aggregation level, a time-domain resource location, a frequency-domain resource location, and a resource mapping mode;

the decoding the DCI to obtain control information includes:

DCI, which is received on different service beams, with the same information content is jointly decoded to obtain the same information content in the DCI.

In one embodiment, the processor may be further configured to:

at least one of transmission formats of the DCI received on different service beams is the same; and that the DCI is decoded to obtain an information content in the DCI includes:

blind detection is performed on the first DCI received on a first service beam to obtain a transmission format of the first DCI;

a format the same as that of the first DCI in a transmission format of second DCI received on the second service beam is determined according to the transmission format of the first DCI;

blind detection is performed on the second DCI received on the second service beam according to the format the same as that of the first DCI to obtain the transmission format in the second DCI; and

the first DCI and the second DCI are decoded respectively according to the transmission format of the first DCI and the transmission format of the second DCI so as to obtain information contents in the first DCI and in the second DCI.

In one embodiment, the processor may be further configured to:

that downlink control information (DCI) is received on M service beams includes:

DCI with different information contents is received on different service beams.

In one embodiment, the processor may be further configured to:

that downlink control information (DCI) is received on M service beams includes:

different information parts in one piece of DCI are received on different service beams;

that the DCI is decoded to obtain control information includes:

the DCI in which the different information parts are received on different service beams is decoded so as to obtain an information content in the DCI.

Other embodiments of the present disclosure will be apparent to those skilled in the art from consideration of the specification and practice of the present disclosure. This application is intended to cover any variations, uses, or adaptations of the present disclosure following the general principles thereof and including common knowledge or commonly used technical measures which are not disclosed herein. The specification and embodiments are to be considered as exemplary only, with a true scope and spirit of the present disclosure is indicated by the following claims.

It will be appreciated that the present disclosure is not limited to the exact construction that has been described above and illustrated in the accompanying drawings, and that various modifications and changes can be made without departing from the scope thereof. It is intended that the protection scope of the present disclosure only be limited by the appended claims.

1. A downlink control information transmission method, which is applied to a base station and comprises:
mapping a physical downlink control channel (PDCCH) carrying downlink control information (DCI) onto N preset physical resources, wherein N≥2 and is an integer; and
transmitting the DCI on different preset physical resources via different service beams.

2. The method according to claim 1, wherein the mapping the physical downlink control channel (PDCCH) carrying the downlink control information (DCI) onto the N preset physical resources comprises:
mapping the DCI with the same information content on each of the N preset physical resources,
wherein a transmission format of the DCI is different or the same, and the transmission format comprises at least one of the following formats: an encoding mode, a DCI format, an aggregation level, a time-domain resource location, a frequency-domain resource location, and a resource mapping mode.

3. The method according to claim 1, wherein the mapping the physical downlink control channel (PDCCH) carrying the downlink control information (DCI) onto the N preset physical resources comprises:
mapping the DCI with different information contents onto each preset physical resource.

4. The method according to claim 1, wherein the mapping the physical downlink control channel (PDCCH) carrying the downlink control information (DCI) onto the N preset physical resources comprises:
mapping the PDCCH carrying one piece of DCI onto the N preset physical resources.

5. A downlink control information transmission method, which is applied to a terminal and comprises:
receiving downlink control information (DCI) on M service beams configured by a base station, wherein M≥2 and is an integer; and
decoding the DCI to obtain an information content in the DCI.

6. The method according to claim 5, wherein the receiving downlink control information (DCI) on M service beams configured by a base station comprises:
receiving the DCI with the same information content on different service beams, wherein a transmission format of the DCI is different or the same, and the transmission format comprises at least one of: an encoding mode, a DCI format, an aggregation level, a time-domain resource location, a frequency-domain resource location, and a resource mapping mode;
the decoding the DCI to obtain the control information comprises:
jointly decoding the DCI, which is received on different service beams, with the same information content to obtain the same information content in the DCI.

7. The method according to claim 5, wherein at least one of transmission formats of the DCI received on different service beams is the same; and the decoding the DCI to obtain an information content in the DCI comprises:
performing blind detection on first DCI received on a first service beam to obtain a transmission format of the first DCI;
determining a format the same as that of the first DCI in a transmission format of second DCI received on a second service beam according to the transmission format of the first DCI;
performing blind detection on the second DCI received on the second service beam according to the format the same as that of the first DCI to obtain the transmission format of the second DCI; and
decoding the first DCI and the second DCI respectively according to the transmission format of the first DCI and the transmission format of the second DCI to obtain information contents in the first DCI and the second DCI.

8. The method according to claim 5, wherein the receiving the downlink control information (DCI) on the M service beams comprises:
receiving the DCI with different information contents on different service beams.

9. The method according to claim 5, wherein the receiving the downlink control information (DCI) on the M service beams comprises:
receiving different information parts in one piece of DCI on different service beams;
decoding the DCI to obtain control information comprises:
decoding the DCI in which the different information parts are received on different service beams so as to obtain an information content in the DCI.

10.-18. (canceled)

19. A downlink control information transmission apparatus, which is applied to a base station and comprises:
a processor;
memory storing a processor-executable instruction;
wherein the processor is configured to:
map a physical downlink control channel (PDCCH) carrying downlink control information (DCI) onto N preset physical resources, wherein N≥2 and is an integer; and
transmit the DCI on different preset physical resources via different service beams.

20. A downlink control information transmission apparatus implementing the method according to claim 5, comprising:
a processor,
memory storing instructions for execution by
the processor to
implement operations of the method.

21. The apparatus according to claim 19, wherein the processor is further configured to:
map the DCI with the same information content on each of the N preset physical resources, to thereby perform mapping the physical downlink control channel (PDCCH) carrying the downlink control information (DCI) onto the N preset physical resources,
wherein a transmission format of the DCI is different or the same, and the transmission format comprises at least one of the following formats: an encoding mode, a DCI format, an aggregation level, a time-domain resource location, a frequency-domain resource location, and a resource mapping mode.

22. The apparatus according to claim 19, wherein the processor is further configured to:
map the DCI with different information contents onto each preset physical resource,
to thereby perform mapping the physical downlink control channel (PDCCH) carrying the downlink control information (DCI) onto the N preset physical resources.

23. The apparatus according to claim 19, wherein the processor is further configured to:
map the PDCCH carrying one piece of DCI onto the N preset physical resources, to thereby perform mapping the physical downlink control channel (PDCCH) carrying the downlink control information (DCI) onto the N preset physical resources.

24. The apparatus according to claim 20, wherein the processor is further configured to:
receive the DCI with the same information content on different service beams, wherein a transmission format of the DCI is different or the same, and the transmission format comprises at least one of the following formats: an encoding mode, a DCI format, an aggregation level, a time-domain resource location, a frequency-domain resource location, and a resource mapping mode, to thereby perform receiving downlink control information (DCI) on M service beams configured by a base station; and
the decoding the DCI to obtain the control information comprises:
jointly decoding the DCI, which is received on different service beams, with the same information content to obtain the same information content in the DCI.

25. The apparatus according to claim 24, wherein at least one of transmission formats of the DCI received on different service beams is the same; and in order to perform decode the DCI to obtain an information content in the DCI, the processor is further configured to:
perform blind detection on first DCI received on a first service beam to obtain a transmission format of the first DCI;
determine a format the same as that of the first DCI in a transmission format of second DCI received on a second service beam according to the transmission format of the first DCI;
perform blind detection on the second DCI received on the second service beam according to the format the same as that of the first DCI to obtain the transmission format of the second DCI; and
decode the first DCI and the second DCI respectively according to the transmission format of the first DCI and the transmission format of the second DCI to obtain information contents in the first DCI and the second DCI.

26. The apparatus according to claim 25, wherein in order to perform receive the downlink control information (DCI) on the M service beams, the processor is further configured to:
receive the DCI with different information contents on different service beams.

27. The apparatus according to claim 25, wherein in order to perform receiving the downlink control information (DCI) on the M service beams, the processor is further configured to:
receive different information parts in one piece of DCI on different service beams;
decode the DCI to obtain control information comprises:
decode the DCI in which the different information parts are received on different service beams so as to obtain an information content in the DCI.

28. A communication system implementing the method according to claim 1, comprising the base station, wherein the base station is configured to jointly transmit the DCI on the different service beams, thereby increasing amount of data being transmitted.

29. The communication system according to claim 28, further comprising a terminal configured to:
receive the DCI on M service beams configured by the base station, wherein M≥2 and is an integer; and
decoding the DCI to obtain an information content in the DCI;
wherein the terminal is further configured to:
determine a format of a second DCI received on a second service beam same as in a transmission format of a first DCI received on a first service beam, obtained through a blind detection, of the first DCI received on a first service beam, thereby reducing number of blind detections of the terminal for blind detection to be performed on the transmission format of the second DCI, and improving information decoding efficiency of the terminal.
